(19) United States
(12) Patent Application Publication
(10) Pub. No.: US 2009/0201129 A1
(43) Pub. Date: Aug. 13, 2009

(54) Authenticity Determination

(75) Inventors: Robert Lane, Brighton (AU); Mark Suhr, South Yarra (AU)

Correspondence Address: DLA PIPER US LLP, 1999 AVENUE OF THE STARS, SUITE 400, LOS ANGELES, CA, 90067-6023, US

(73) Assignees: STANNARDS ACCOUNTANTS, South Yarra, Victoria (AU); SURPION PTY LTD (STF M.W. SUHR & CO TRUST), South Yarra Victoria (AU)

(21) Appl. No.: 11/910,728

(22) PCT Filed: Apr. 7, 2006
(86) PCT No.: PCT/AU06/00461

§ 371 Date: Nov. 19, 2008

(30) Foreign Application Priority Data
Apr. 7, 2005 (AU) 2005901715

(51) Int. Cl. H04Q 5/22; G06Q 40/00

(52) U.S. Cl. 340/10.1; 705/4

(57) ABSTRACT

A method of determining the authenticity of an article. The method utilises a tag having a tag data store, which is coupled to the article. The method includes in a tag reader, determining article information from the tag data store. The article information is then compared to predetermined information obtained from the tag store, a database, a second tag provided on the article or the article itself, thereby allowing the article to be authenticated based on the result of the comparison. This can be used for offering reduced insurance premiums.

### BACKGROUND OF THE INVENTION

The present invention relates to a method and apparatus for allowing the authenticity of an article to be determined, and in particular to an RFID type authenticity tracking system.

### DESCRIPTION OF THE ART

The reference to any prior art in this specification is not, and should not be taken as, an acknowledgment or any form of suggestion that the prior art forms part of the common general knowledge.

Currently there is a need to be able to accurately identify and determine the authenticity of articles. Whilst this has previously been achieved using printed serial numbers, such techniques have a number of drawbacks, including the ability for serial numbers to be fraudulently changed or interchanged.

In order to overcome such problems, RFID systems have been developed which utilise a tag having a processor and associated antenna. In use, data is stored in the tag by the processor, allowing the data to be subsequently retrieved by a suitable reader. To achieve this, the reader generates a signal that inductively couples the tag to the reader. This allows power to be supplied to the tag processor, which in turn uses backscatter modulation of the read signal to allow information to be transmitted to the reader.

However, such systems suffer from a number of drawbacks. Firstly, in most systems the volume of data that can be stored on the tag is limited. Secondly, there are issues surrounding security of the data stored on the tag. In particular, as line of sight is not required between the tag and the reader, there is potential for any individual with a reader to obtain access to data stored on tags. As a result, there are significant drawbacks in using the tags to store personal information or the like.

### SUMMARY OF THE PRESENT INVENTION

In a first broad form the present invention provides a method of determining the authenticity of an article, the method utilising a tag having a tag data store, and wherein the method includes:
a) in a tag reader, determining article information from the tag data store;
b) comparing the article information to predetermined information, the predetermined information being obtained from at least one of.
   i) the tag store;
   ii) a database;
   iii) a second tag provided on the article; and,
   iv) the article; and,
c) authenticating the article dependent on the result of the comparison.

Typically the method includes, in the tag reader, and in response to determining the article information, at least one of:
a) displaying the article information to allow visual comparison with the predetermined information; and,
b) comparing the article information to the predetermined information.

Typically the predetermined information includes a digital signature and wherein the method includes, in the tag reader, at least one of:
a) decrypting the digital signature and comparing the decrypted digital signature to the article information; and,
b) encrypting the article information and comparing the encrypted article information to the digital signature.

Typically the article information is at least partially encrypted to thereby prevent unauthorised access or alteration of the article information.

Typically the article information includes:
a) a payload, the payload including the article information encrypted using a secret key; and,
b) a header, the header being indicative of the secret key, and wherein method includes, in the tag reader:
   i) determining, from the header, an indication of the secret key;
   ii) obtaining the secret key from a data store using the secret key indication; and,
   iii) decrypting the payload using the secret key.

Typically the method includes, in a tag reader:
a) determining an operator identifier indicative of an identity of an operator;
b) authenticating the operator using the operator identifier; and,
c) authenticating the article in response to a successful operator authentication.

Typically the method includes, in the tag reader:
a) receiving the operator identifier from the operator;
b) comparing the operator identifier to a number of predetermined operator identifiers stored in a data store; and,
c) authenticating the operator in response to a successful comparison, wherein the operator identifier includes at least one of:
   i) a biometric signature;
   ii) a password; and,
   iii) a PIN.

Typically the method includes, in the tag reader:
a) determining from the article information at least one article information access level;
b) determining, using the operator identifier and from operator details stored in a data store, one or more operator access levels;
c) comparing the article information access levels to the operator access levels; and,
d) authenticating the article in response to a successful comparison.

Typically the tag is an RFID tag, and wherein the method includes, in the tag reader, determining the identifier by:
a) generating a read signal, the tag being responsive to the read signal to modulate the read signal in accordance with the article information;
b) detecting modulation of the read signal; and,
c) determining the article information using the detected modulation.

Typically the article information includes at least one of:
a) a unique article id;
b) manufacture information;
c) purchase information;
d) sales information;
e) insurance details; and,
f) owner details.

Typically the at least one tag is embedded within the article.

Typically the at least one tag is embedded within the article during manufacture.

Typically the article information is locked so that it cannot be altered

Typically the article is a vehicle.

Typically the article is a bicycle, and wherein the method is used for obtaining an insurance premium reduction relating to the bicycle.

In a second broad form the present invention provides apparatus for determining the authenticity of an article, the article including a tag having a tag data store, and wherein the apparatus includes a tag reader for:
a) determining article information from the tag data store; and,
b) allowing a comparison of the article information to predetermined information, to thereby authenticate the article dependent on the result of the comparison, the predetermined information being obtained from at least one of.
   i) the tag store;
   ii) a database;
   iii) a second tag provided on the article; and,
   iv) the article; and,

Typically the tag reader includes at least one of:
a) a display for displaying the article information to allow visual comparison with the predetermined information; and,
b) a processor for comparing the article information to the predetermined information.

Typically the tag reader includes a communications system for communicating with a remote database to thereby determine the predetermined information.

In a third broad form the present invention provides a method for use in determining the authenticity of an article, the method utilising a tag having a tag data store, and wherein the method includes:
a) in a tag reader, storing article information in the tag data store; and,
b) providing predetermined information, the predetermined information being used to authenticate the article by comparing the predetermined information to the article information, the predetermined being provided at least one of.
   i) in the tag store;
   ii) in a database;
   iii) in a second tag provided on the article; and,
   iv) on the article.

Typically the article information and predetermined information are used in the method of the first broad form of the invention.

Typically the method includes providing a discounted insurance premium associated with the article.

In a fourth broad form the present invention provides apparatus for use in determining the authenticity of an article, the article including a tag having a tag data store, and wherein the apparatus includes a tag reader for storing article information in the tag data store, the article information being related to predetermined information to allow authentication of the article by comparing the predetermined information to the article information, the predetermined being provided at least one of.
a) in the tag store;
b) in a database;
c) in a second tag provided on the article; and,
d) on the article.

Typically the apparatus is used in the method of the third broad form of the invention.

In a fifth broad form the present invention provides a method associated with insuring an article, the method including:
a) providing an article authentication mechanism by:
   i) storing article information in a tag having a tag data store, the tag being attached to the article;
   ii) providing predetermined information for use in authenticating the article, the predetermined information being provided at least one of.
      (1) in the tag store;
      (2) in a database;
      (3) in a second tag provided on the article; and,
      (4) in the article; and,
b) insuring the article, the insurance premium being at a reduced level compared to the premium payable if the article did not include the authentication mechanism.

Typically the method includes, having an insuring entity at least partially provide the authentication mechanism by at least one of:
a) generating at least one of the article and the predetermined information;
b) arranging to attach the tag to the article; and,
c) storing the predetermined information in a database.

Typically the authentication mechanism is for allowing the article to be authenticated using the method of the first broad form of the invention.

In a sixth broad form the present invention provides a method associated with an insured article, the method including:
a) in a tag reader, determining article information from the tag data store;
b) comparing the article information to predetermined information, the predetermined information being obtained from at least one of.
   i) the tag store;
   ii) a database;
   iii) a second tag provided on the article; and,
   iv) the article; and,
c) authenticating the article dependent on the result of the comparison.

Typically the method includes:
a) in the tag reader, transferring the article information to an insuring entity; and,
b) having the insuring entity authenticate the article.

Typically the predetermined information is stored in a database administered by the insuring entity.

### BRIEF DESCRIPTION OF THE DRAWINGS

An example of the present invention will now be described with reference to the accompanying drawings, in which:—

FIG. 1 is a schematic diagram of an example of a data tag;

FIG. 2 is a schematic diagram of an example of a tag reader;

FIG. 3 is a schematic perspective view of an the tag reader of FIG. 2;

FIG. 4 is a schematic diagram of an example of a computer system;

FIG. 5 is a flow chart outlining an example of the process of interacting with a tag;

FIG. 6 is a flow chart of an example of the process of registering an operator with a tag reader;

FIG. 7 is a flow chart of an example of the process of writing article information to a tag;

FIG. 8 is a flow chart of an example of the process of reading article information from a tag;

FIG. 9 is a flow chart of an overview of an example of a process for maintaining an audit trail relating to an article;

FIGS. 10A to 10D are a flow chart of an example of a process for maintaining an audit trail relating to an article; and,

FIGS. 11A and 11B are a flow chart of the process of authenticating a bike.

### DETAILED DESCRIPTION OF THE PREFERRED EMBODIMENTS

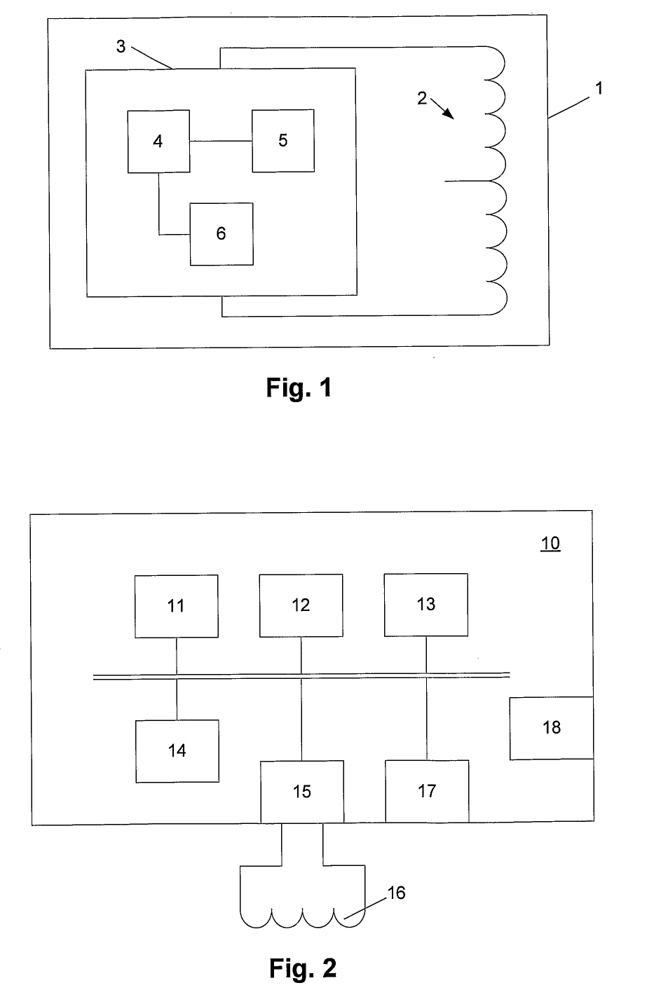

An example system will now be described with reference to FIGS. 1 to 4, which show a tag, an associated tag reader/writer (hereinafter referred to generically as a “tag reader”) and a computer system that may be used with the tag reader.

FIG. 1 is a schematic diagram of an example of a tag that may be coupled to an article, such as a vehicle (including an automobile, truck, car, boat, ship, train, or the like), and which is capable of performing two-way communication with an associated tag reader. In this example the tag 1 includes an antenna 2 coupled to a controller 3, which is typically a microprocessor that provides desired data storage and output functionality. To achieve this, the controller 3 typically includes a processor 4, a memory 5 and a modulator 6 as shown.

In use, the tag receives a signal via the antenna 2, from an associated reader 10, allowing the tag to perform two-way communication with the reader, thereby allowing information stored on the tag to be retrieved and viewed.

In one example tag, known as a passive tag, the controller 3 rectifies the received signal to obtain power, which is supplied to the controller 3, to allow data storage and output to be performed. In a second example, known as an active tag, the tag includes a power supply, such as a battery 7, which is used to power the controller 3. In general, as active tags do not need to obtain power by rectification of a received signal, they have a greater range than passive tags, but conversely typically have a lifespan that is limited to the life of the battery. In this instance, the active tags may implement memory with a smaller memory capacity to thereby minimise the amount of information that is transferred from the tag to the reader, which in turn increases battery life. In this instance, it may therefore be typical to store only a unique identifier in the tag memory, which is then used to cross reference the remote database allowing relevant information to be viewed.

The tag 1 may be used to store article information related to a respective article. This may be achieved either by storing a unique identifier that can be used to cross reference a remote database containing article information relating to the article, or can alternatively be used to store the article information directly on the tag itself, depending on the preferred implementation.

The tag may be used to store article information related to a respective article. This may include for example at least one of:
a unique article id;
manufacture information such as:
   manufacturer's identity;
   article make/model;
   year/date of manufacture;
   any other related information.
purchase information such as:
   date of purchase;
   owner information;
sales information such as:
   date of sale;
   seller/dealer information;
   an authority for sale from the previous owner;
insurance details;
owner details such as:
name; and,
address.

It will be appreciated that the article information stored and retrieved on the tag will have various applications, as will be described in more detail below.

The tag 1 may be coupled to a vehicle using various methods. For example the tag may be attached directly the vehicle frame or chassis, be inserted into a chamber of a frame included in the vehicle, such as a neck of a bicycle seat. Other methods of coupling the tag to the vehicle may include incorporating the tag in the form of a plate which is coupled to the engine or other suitable parts of the vehicle, or in the form of an identity card that can be attached to a suitable part of the vehicle, as will be described in more detail below.

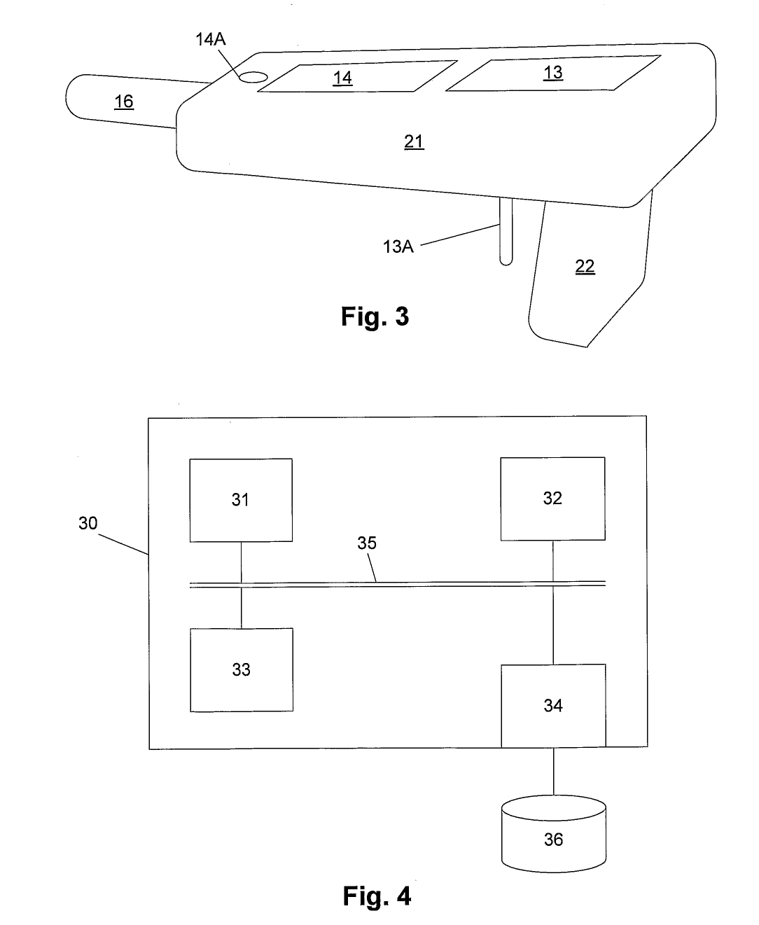

An example of a reader is shown in FIGS. 2 and 3. In particular, the reader 10 includes a processor 11 coupled to a memory 12, an input device 13, a display 14, a modulator 15 and an external interface 17 via a bus 18 as shown. The modulator 15 is coupled to an antenna 16.

In use, the modulators 6, 15, and the associated antennas 16, 2, when positioned in close proximity, form an inductively coupled tuned circuit. Accordingly, passing an alternating current through the antenna 16 causes a corresponding current to be induced in the antenna 2. In use, the modulators 6, 15 can be used to alter the inductance, and hence the resonant frequency of the tuned circuit. This in turn allows information to be transferred between the tag 1 and the reader 10.

Thus, generation of a suitably modulated signal by the modulator 15 can be detected by the modulator 6, allowing data to be written to the tag 1. In this case, the processor 4 interprets the modulated signal, and writes the received data into the memory 5. Conversely, the modulator 6 can be used to modulate the signal induced in the antenna 2, thereby causing backscatter modulation of the signal generated by the modulator 15, which can be detected by the modulator 15, allowing data to be read from the tag 1.

It will be appreciated by persons skilled in the art that in one example this is therefore an RFID type tag system. In this case, modulation of the signals can be either phase or amplitude modulation, with the coupling between the tag and the reader being either inductive (as described above) or capacitive, depending on the preferred implementation.

An example of the external configuration of the reader 10 is shown in FIG. 3. As shown, the reader 10 includes a housing 20 having a main portion 21 coupled to a handle 22. The housing typically includes the display 14, optional additional display indicators 14A, and the input device 13, typically in the form of a keypad entry system 13, or the like, mounted thereon. Additional input control such as trigger 13A may also be used as shown.

In one example, the antenna 16 is in the form of a telescopic antenna as shown in FIG. 3. Alternatively the antenna may be contained provided within the main housing 21 depending on the intended use, as will be described in more detail below.

Typically the reader 10 is also adapted to communicate via the external interface 17 with a computer system, shown generally at 30 in FIG. 4. Typically the computer system includes a microprocessor 31 coupled to a memory 32, an input/output device 33, such a keyboard and display or the like, and an external interface 34, coupled together via a bus 35 as shown. The computer system 30 may be coupled to a remote database 36, via the external interface 34, as shown.

Additionally, or alternatively, the external interface 34 may be coupled to the external interface 17 of the reader 10, such as through the use of an RS232 serial connection, USB connection, wireless Bluetooth connection, or the like. In use the processors 11, 31 execute application software that allows the reader 10 and the computer system 30 to communicate and transfer data therebetween as required. Additional functionality may also be provided as will be described in more detail below.

It will therefore be appreciated that the computer system 30 may be any form of a computer system such as a desktop computer, lap-top, palm-top, specialised hardware or the like. Similarly, the processor 11 utilised by the reader 10 can be implemented in a variety of forms and may be formed from a Programmable Logic Array (PLA), specialised hardware or the like.

In use, the system allows article information to be stored and subsequently retrieved using the reader 10 alone, or using a combination of the reader 10 and the computer system 30.

In one example of the invention, the tag 1 is a tag having a high data storage capacity, such as a 125 kHz Hitag S 2048 RFID tag. This allows a significant amount information, and in particular, up to 1920 bits or 240 characters, to be stored directly on the tag, without necessarily requiring access to a remote database.

In such a system, as tags may be read remotely and using any appropriate reader, there is the potential for any information stored on the tag to be accessed by third parties. As in many applications to the tag will contain confidential information such as user details, this is undesirable. Accordingly, in order to ensure that privacy of the information is maintained, the system typically utilises a strong encryption technique so that the information is stored on the tag 1 in an encrypted format. This, coupled with controlled dissemination of the secret keys, ensures the information remains secure.

However, in an alternative example in which the data capacity of the tag is smaller, such as if an active tag is used, then it is typical for the tag to store only a unique reference number or other identifier. This is used to access a remote secondary database storing the article information. In this instance, the reference number stored on the tag is mapped to a database entry for the respective vehicle, for the time the tag is associated with the vehicle, as will be described in more detail below. In this instance, the reference number on the tag is typically locked to prevent alteration. Furthermore, as the database can contain confidential information, it is also typical for the information in the remote database to be locked to prevent alteration and unauthorised access. This can be performed in a manner similar to the encryption of data on a high capacity tag, as will be described in more detail below.

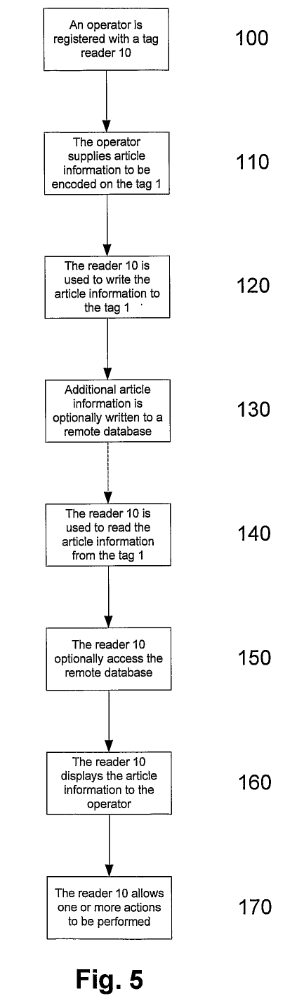

An example of use of the system will now be described with reference to FIG. 5.

At step 100 an operator undergoes a registration procedure, which associates the operator with one or more respective tag readers 10. This creates a unique association between the operator and the reader(s) 10, so that only validly registered operators may use the readers 10. This may be a one off procedure, and is not necessarily required each time information is to be written to a tag.

At step 110 article information is provided either to the reader 10, via the computer system 30 or the input device 13, or directly to the computer system 30, allowing the article information to be stored. In the case of a passive tag, the article information is stored on the tag. However, in this example, the article information is stored in a remote database at step 120, and associated with an identifier stored on the tag at step 130. This is typically achieved by using the reader 10 to determine the identifier, and then store this with the article information in the database.

These steps, which represent the writing procedure, may be performed by any one of a number of entities depending on the circumstances in which the process is used. For example, if the tag is used to track a vehicle during an export process parties taking part in the export procedure may all need to write information to the tag. Alternatively, if the tag is to track events relating to a vehicle during its life from manufacture, parties may include the manufacturer, as well as any mechanics performing work on the vehicle, registration authorities, or the like.

Once the writing procedure is complete, the information can be read from the tag using the reading process outlined in steps 140 onwards.

In particular, at step 140 a reader 10 reads the identifier from the tag 1, and uses this to access the remote database 36 at step 150. This allows the reader 10, or the computer system 30 to display the article information to the operator at step 160. One or more actions associated with the provided information may then be performed at step 170.

It will be appreciated that the process may be performed other entirely by the reader 10, or partly by the reader 10 in conjunction with the computer system 30. Thus, for example, information to be written to the tag may be input into the computer system 30 and then subsequently uploaded to the reader 10. This may be used if the computer system 30 has a more user friendly input interface that allows for easier entry of the data. For clarity the following description will focus on the process being performed by the reader 10, although it will be appreciated that all of the processes may be performed by the reader 10 in conjunction with the computer system 30, depending on the preferred implementation.

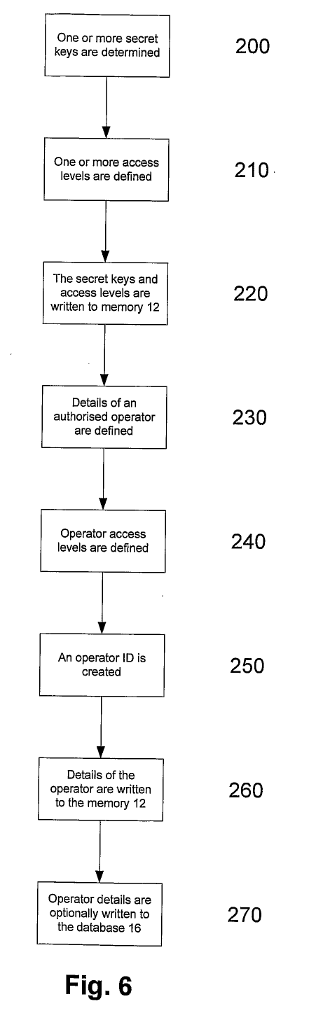

An example of a procedure in which article information is encrypted will now be described in more detail with respect to FIGS. 6, 7 and 8.

In this example, the operator is registered with a reader to reduce availability of access to the article information. The procedure for registering an operator to use the reader is set out in FIG. 6.

In this example, the process is generally separated into a reader initialisation phase at steps 200 to 220, and an operator registration at steps 230 to 270. During the reader initialisation phase, as shown at step 200, one or more secret keys are generated, with the secret keys being used for encrypting specific types of information.

The secret keys can be shared amongst a number of readers to allow a number of readers to access the data provided on a tag 1, in which case the keys may be obtained from a database or the like. Alternatively, the secret key may be new, for example if it is unique to respective reader 10, or if it is the first time a respective type of information is to be used, in which case the ley may be generated using a predetermined algorithm. Whilst any form of secret key encryption system may be used, in one example the system uses a 128 bit AES encryption protocol and based on a 64 bit secret key.

At step 210 it is possible to define one or more access levels. These represent an access right associated with information that is to be provided to the tags, thereby allowing access to information to be selectively restricted so that different operators may be assigned different access rights. At step 220 the keys and details of the access levels are stored in the memory 12 of the reader 10 using conventional techniques.

Steps 200 and 220 may only need to be defined the first time the reader 10 is used. Alternatively, depending on the respective circumstances these may be repeated as often as required.

At step 230 operator details are defined associated with one or more operators of the reader 10. The operator details may include a range of information such as the operator's name and other personal information, details of employment, employers, or the like. Access levels associated with the operator are then defined at step 240. Thus, if a number of operators are associated with the reader 10 is may be desirable that some information stored on the tag 1 is only viewable by certain operators, in which case those operators may be provided with a different access level. Access levels may also be used to control writing of information to tags 1, depending on the circumstances in which the situation is used.

At step 250 an operator ID is created to allow the operator to be authenticated by the reader 10. The nature of the ID will depend on the authentication mechanism used and will be discussed in more detail below.

At step 260, details of the operator including at least the operator ID and any access levels associated with the operator are stored in the memory 12 of the reader 10. Further details may also be stored in the remote database 36 to allow these to be accessed or updated independently of the reader 10. As an alternative to the procedure described above, the operator details may be stored solely in the database 36, in which case when authentication of the operator is performed, then this requires the reader 10 to access the remote database 36.

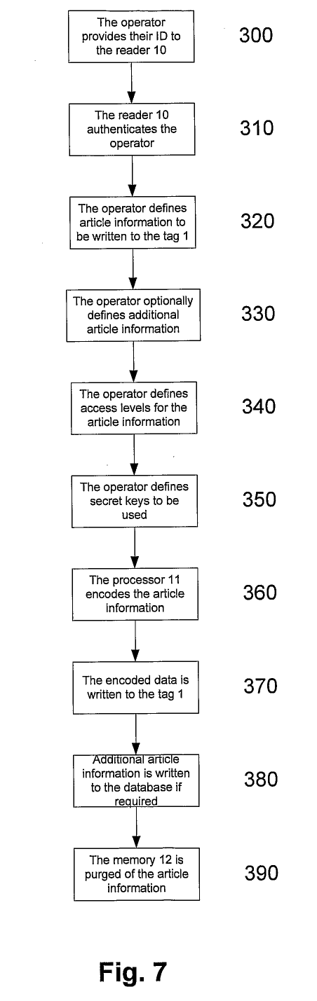

In any event, an example of use of the reader 10 to write information to the tag 1 will now be described with reference to FIG. 7.

In particular at step 300 the operator is required to supply their ID to the reader 10. The manner in which the ID is supplied will depend on the authentication mechanism used as discussed in more detail below. At step 310 the reader 10 will operate to authenticate the operator by comparing the received ID to the operator ID stored in the memory 12 at step 260. If the IDs match, the operator is authenticated and the process proceeds to step 320, allowing the operator to define article information to be stored on the tag. The information may be entered via the input 13 or alternatively via the computer system 30, which then transfers the article information to the reader 10 via the external interface 17. The operator may also define additional optional article information for storage in a remote database at step 330.

At step 340 the operator defines one or more access levels associated with the article information. A single access level may be defined for all of the information, or alternatively, different portions of the information may be associated with different access levels, depending on the information's sensitivity.

For example, the article information may include manufacturer information and/or owner information as discussed in above. In certain situations, it may be appropriate that a particular operator may only be able to read the manufacturer information, whilst another operator which may be able to read and write both owner and manufacturer information. Various levels of authorisation such as access flags may be used to indicate the access levels of data for particular operators, as will be described in more detail below.

In order to ease entry of the information, it is typical for the user to be presented with a GUI (graphical user interface), which includes fields into which the information may be entered. The respective fields presented may depend on the type of information provided. In any event, this can allow the user to associate different access levels with the different fields, thereby easily designating the access levels.

At step 350 the reader 10 is used to select a secret key associated with the article information. This may be selected automatically by applications software executed by the processor 11, for example depending on the type of information entered, or may alternatively be selected by the operator. In addition to this, it will be appreciated that the key may be a predetermined key, or alternatively may be generated in-situ utilising an appropriate algorithm.

It will be appreciated that the information may also be encrypted using two or more secret keys, including for example providing a respective secret key for each access level.

Thus, as previously described, the article information may include manufacturer information and owner information, and therefore a separate secret key set may be used to provide additional security so as to prevent unauthorised access to certain parts of the article information.

At step 360 the processor 11 operates to encode the data using the one or more secret keys.

In particular, the processor 11 will operate to generate a binary string representing the article information to be stored on the tag, together with details of the associated access levels. This will typically be achieved by encoding the article information as a character string, using associated flags to define the access level.

The resulting string is then encrypted using the selected secret key, to generate an encrypted string. The encrypted string is then associated with a header indicative of the secret keys to encrypt data. The encrypted string will hereinafter be referred to as a payload, with the combined payload and header forming a data packet.

At step 370 the data packet is written to the tag 1. This is achieved by having the processor 11 control the modulator 15, causing the modulator to generate a write signal modulated in accordance with the encoded data. It will be appreciated that write the signal generated by the modulator 15 will inductively couple power to the controller 3, with the modulation being detected by the modulator 6. The processor 4 interprets the modulation to determine the data packet and writes this to the memory 5.

This process is generally performed as a WORM (write once, read many) process, so that the data cannot be subsequently altered, although this is not essential. An example of information that may be used in a WORM process includes manufacturer data, as this information remains constant over the article's life, and as such should not require editing. However, in contrast, owner information may change over the article's lifetime and as such this information would not be appropriate to be stored in a WORM format.

Additionally, at step 380 the reader 10 or the computer system 30 may write additional article information to the remote database 36.

If this is performed, a unique identifier is stored as part of the data packet, and as part of the information stored in the database 26, thereby allowing the article information stored in the database 36 to be subsequently associated with the respective tag 1. An example of such additional article information may include distinctive physical indicia of the article, such as the inclusion of an airfoil, sunroof, or floodlights.

At step 390 the contents of the memory 12 in the reader 10 and additionally the contents of the memory 32 and the computer system 30 are purged to thereby ensure the article information is not retained on the device. This helps further ensure the confidentiality of the information.

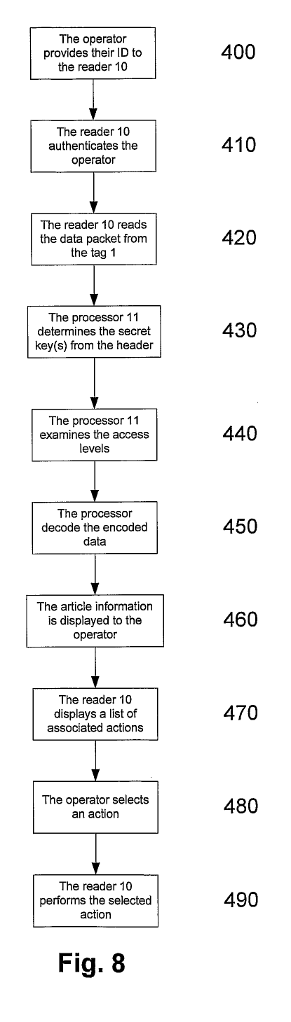

The manner in which information is read from the tag will now be described with reference to FIG. 8.

In particular at step 400 the operator supplies their ID to the reader 10, thereby allowing the reader 10 to authenticate the operator at step 410.

At step 420 the operator activates the reader 10, for example using the trigger 13A, and then places the reader 10 adjacent the tag 1, thereby causing the reader 10 to read the data packet from the tag 1.

It will be appreciated that this is generally achieved by having the processor 11 cause the modulator 15 to generate a read signal, which is an alternating signal with no modulation. The read signal inductively couples power to the tag 1 thereby powering the controller 3. This in turn causes the tag processor 4 to access the data packet stored in the memory 5, and then cause the modulator 6 to modulate the resonant frequency of the tuned circuit. This in turn alters the phase or amplitude response of the tuned circuit, which is detected by the modulator 15, thereby allowing the processor 11 to determine the data packet.

In one example, the tag processor 4 and the processor 11 undergo an authorisation procedure in which the tag processor 4 confirms that the reader 10 is authorised to read data from the tag 1. This may be achieved for example by having the processor 11 provide authentication information such as an identifier, a password, a digital signature, or the like. This can be used to prevent the article information being read from the tag 1 by any mechanism other than an authorised reader which in turn helps prevent data being copied to another tag 1, to allow a duplicate tag to be created. The authentication mechanism used can vary depending on the level of security required. However alternative safeguards maybe used to allow prevent duplicated tags from being of use, as will be described in more detail below.

The processor 11 then operates to read the data packet header at step 430, and determine the one or more secret keys used in encrypting the payload. The processor 11 also operates to determine any access levels associated with the article information, at step 440. This allows the processor 11 to compare the access level of the operator with the access level of the article information and assess whether the operator is authorised to view some, or all, of the article information.

The processor 11 decrypts the payload using the secret keys at step 450. In one example, the article information can be encrypted such that parts of the data having a common access level may be decrypted independently from data having a different access level. As a result, in this example, only parts of the article information which the operator is authorised to view will be decrypted.

This article information is then presented to the operator at step 460, using the display 14. Alternatively, or additionally, the information may be displayed on the computer system 30.

At this point, if information is stored in the remote database 36, the processor 11 will determine this due to the presence of the unique identifier. In this case, the reader 10 will access the database 36 if possible, for example via a wireless network, such as the mobile phone, GPRS network, or the like, and display the additional information to the operator. Alternatively, if the database 36 cannot be accessed, then this may be indicated to the operator on the display 14, allowing the article information to be retrieved at a later opportunity.

In addition to displaying the article information, the reader 10 may be adapted to allow one or more actions to be taken relating to the article information. Whilst this does not generally include alteration of the article information stored on the tag 1, this could include using the article information for certain purposes, as will be described in more detail below.

In this case, the processor 11 will determine a list of actions associated with the article information or other available actions depending on the implementation and display these to the operator at step 470. This is typically achieved by having the processor 11 execute applications software, which is stored in the memory 12, and which is specific to the respective use of the reader 10, as will be appreciated by a person skilled in the art.

At step 480 the operator provides appropriate input, thereby allowing the reader 10 to perform respective actions at step 490, in accordance with instructions defined in the applications software.

### Audit Trail

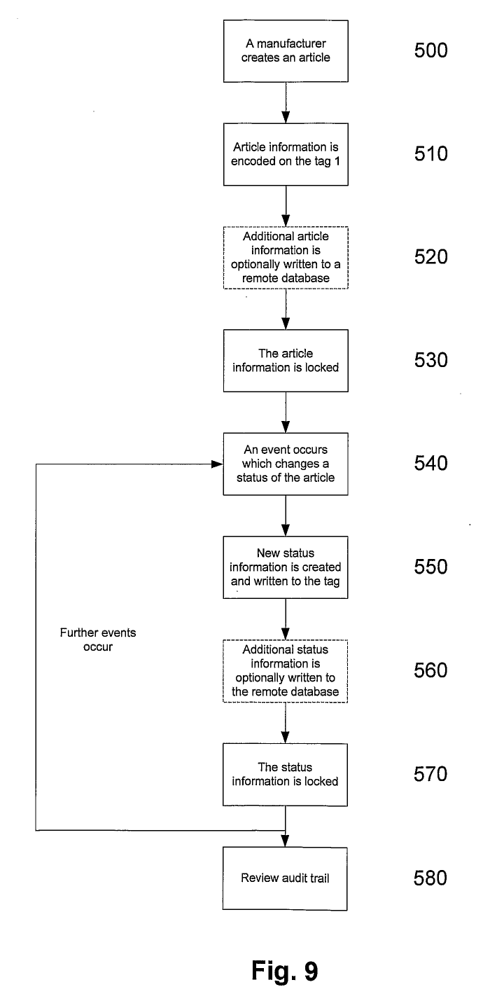

An example of an audit trail process will now be described with reference to FIG. 9.

At step 500, a manufacturer creates an article, and at step 510 article information is encoded on the tag. The article information includes a number of different types of data as will be described below in more detail.

At step 520, additional article information is optionally written to a remote database. Once the article information is written to the tag, the article information is locked at step 530 so that the article information may not be altered.

At step 540, an event occurs changing the status of the article, and accordingly new status information is generated reflecting this change, and written to the tag at step 550. The event and status of the article may typically include the transfer of the ownership of the article, as described in more detail below.

At step 560, additional status information is optionally written to the remote database. Once the status information is written to the tag, the status information is locked at step 570 such that the status information may not be altered.

When further events occur, steps 540 through to 570 are repeated for the particular event, as will be described in more detail below.

At the completion of step 570 the stored information on the tag in the form of an audit trail may be reviewed at step 580, so as to determine the transfer history or related information of the article. However, it will be appreciated that the audit trail review may be performed prior to or during step 540, as will be discussed in more detail below.

It will be appreciated that this process creates an audit trail, which is stored in the tag, and which reflects events that have occurred with respect to the article. This allows the history of individual articles to be subsequently retrieved and reviewed.

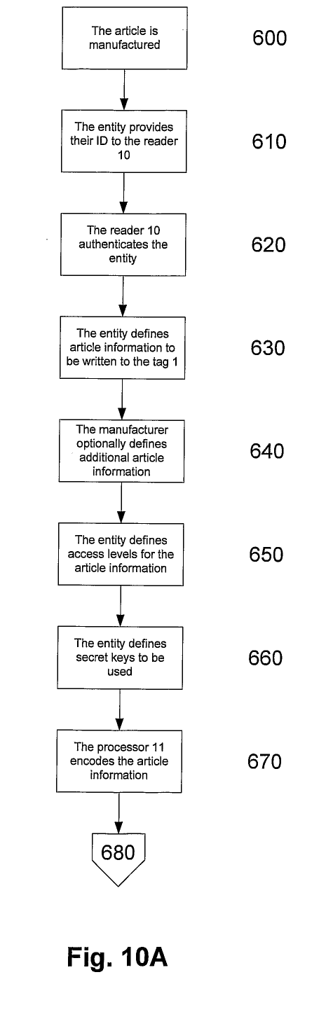

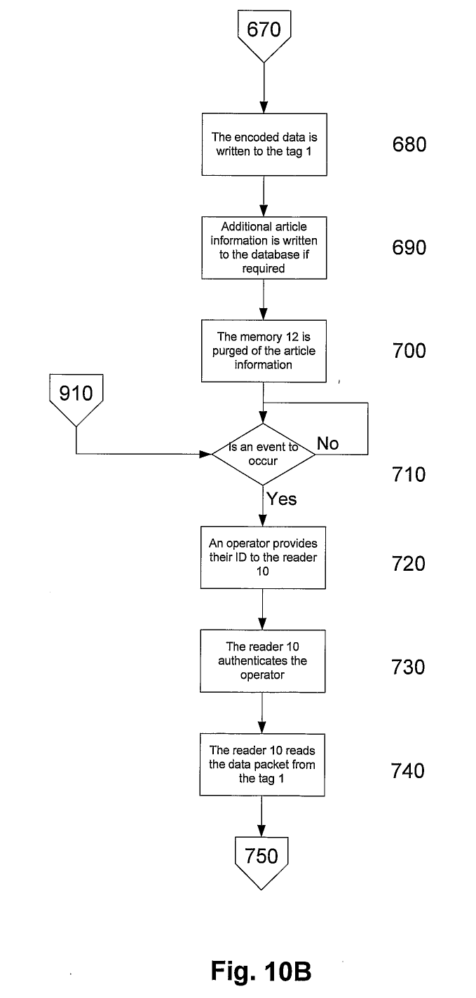

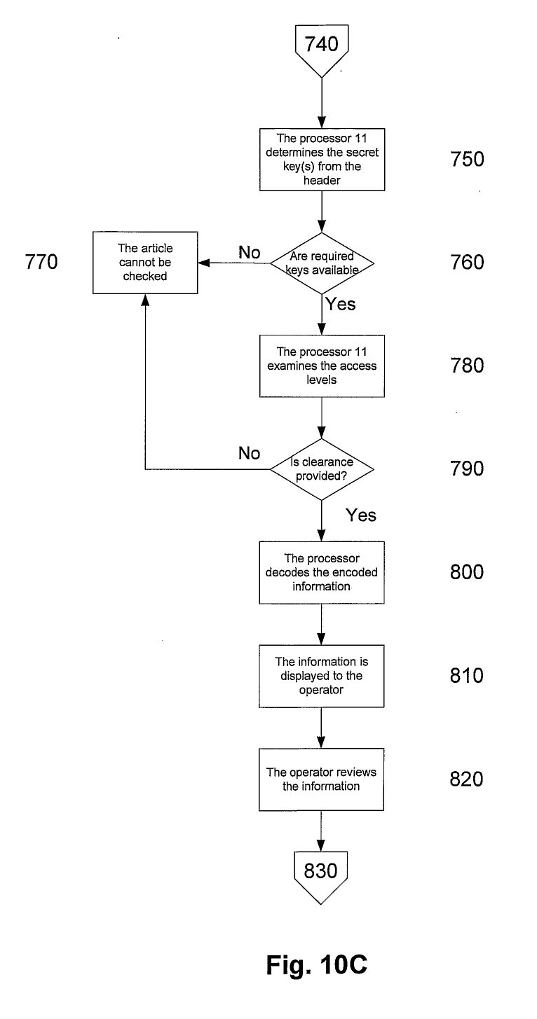

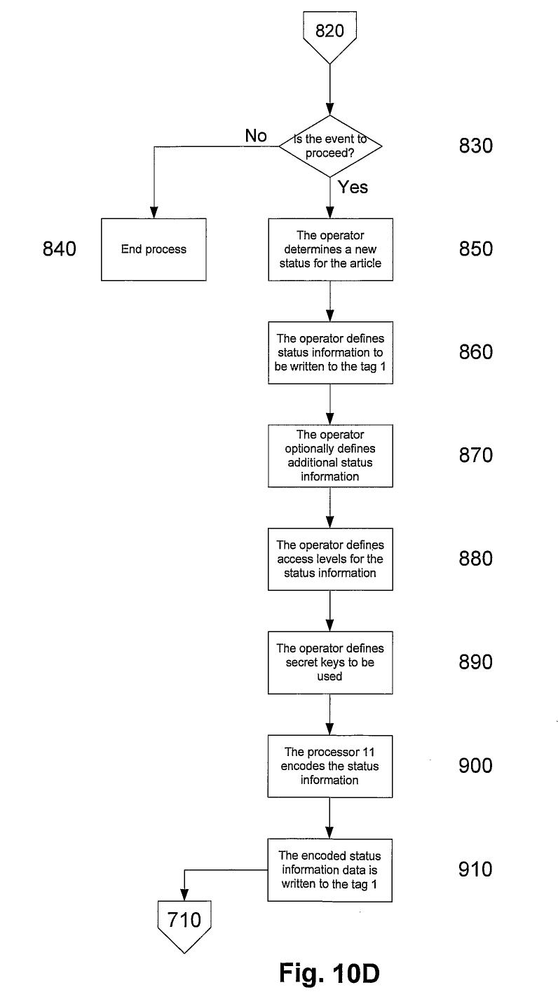

This process of creating an audit history for an article will now be described in more detail with respect to FIGS. 10A to 10D.

In particular at step 600 the article is manufactured at step 610 an entity provides their ID to the reader 10 allowing the reader 10 to authenticate the entity at step 620. The entity then defines article information to be written to the tag 1 at step 630. The article information used will depend on the circumstances in which the process is used and the article in question, but will typically include information regarding the manufacturing of the article, article properties and attributes, relevant dates, or the like.

It will therefore be appreciated that the entity may be the manufacturer, although any suitable entity may provide the information, such as trader, or the like. In one example, this could be performed by an auditor or other inspector whom is required to inspect the article prior to its sale.

At step 640 additional article information may also optionally be defined.

At step 650 the entity defines access levels for the article information with secret keys being defined at step 660 to allow the article information to be encrypted. At step 670 the processor 11 encodes the article information and then writes this to the tag 1 at step 680.

At this point, when the article information is written to the tag 1 the article information will be in the form of a data packet formed from a header and a payload. The payload will contain the article information and will typically be encrypted so that the payload can only be decrypted using the secret keys defined at step 650. The header of the data packet will also typically contain details regarding the secret keys used to encrypt the payload, as well as additional settings such as access levels, or the like.

The header or the payload will also typically include a flag indicating that the article information is “write only” information. As a result of this, once the information is written to the tag 1 it cannot be erased or modified. However, it is possible to add additional information as will be described in more detail below.

At step 690 if additional article information has been provided this is written to a remote database is required. The memory 12 of the reader 10 is then purged of the article information thereby ensuring that this cannot subsequently be determined from the tag reader 10.

At step 710 it is determined if an event is to occur relating to the article. The event may be any form of event that is to be recorded and this will therefore depend on the article and the circumstances in which the article is being used. Typically however events will occur things such as changes in ownership, changes in location, changes in operational status or the like.

If no event occurs then no further action is taken. However, when an event is to occur, it is possible to either check existing details, to confirm the event is to occur, or to provide further details, reflecting the event. Typically both of these stages are performed in sequence as will now be described, although it will be appreciated that this is not essential.

In any event, at step 720 an operator provides their ID to the tag reader 10, allowing the reader 10 to authenticate the operator at step 730 and then obtain any data packets stored on the tag at step 740.

The processor 11 determines the secret keys from the header of the data packet at step 750 before determining if the required keys are available at step 760. If the required keys are not available then it is determined by the reader 10 that the article information cannot be checked at step 770. After this the process may end, required keys may be obtained or another reader 10 may be used, depending on the preferred implementation.

Otherwise the process moves on to step 780 at which point the processor 11 examines the access levels assigned to the respective user. If clearance is not provided to the user at step 790 then the process returns to step 770 and access to the information is refused.

Assuming that the information on the tag 1 may be viewed, then the processor 11 decodes the encoded information at step 800 and displays this to the operator at step 810. This allows the operator to review the information at step 820 and assess whether the event is to proceed.

Thus for example if a reseller is obtaining an article for sale, it will be typical for the reseller to perform a check of the article information prior to purchasing the article. This is performed to ensure that the article is a genuine article or manufactured by a indicated entity, thereby ensuring that the article is not fraudulent or that the article meets certain required safety standards. If it is determined that the event is not to proceed, at step 830, the process ends at step 840.

Otherwise the operator determines a new status for the article at 850 and then operates to define status information to written to the tag 1 at step 860, with additional status information being optionally defined at step 870.

At step 880 the operator defines access levels for the status information before defining secret keys to be used to encode the information at step 890. The processing system 11 then encodes the status information at step 900 and then writes the encoded status information to the tag at step 910, in a similar manner to that described above with respect to the article information. Additional information may be written to the database if required at step 920 before the memory 12 of the reader is purged of the information at step 930.

Again in this instance, it will be appreciated that all information written to the tag 1 is locked so that it may not subsequently be altered.

Accordingly it can be seen from this that this provides a mechanism allowing an audit history of an article to be checked before events are performed. In the event where checking is not required, steps 740 to 830 may be omitted so that the system merely operates to add additional information to the tag without checking previous information. This may be required in some circumstances depending on the utilisation.

### Authenticity Determination Procedure

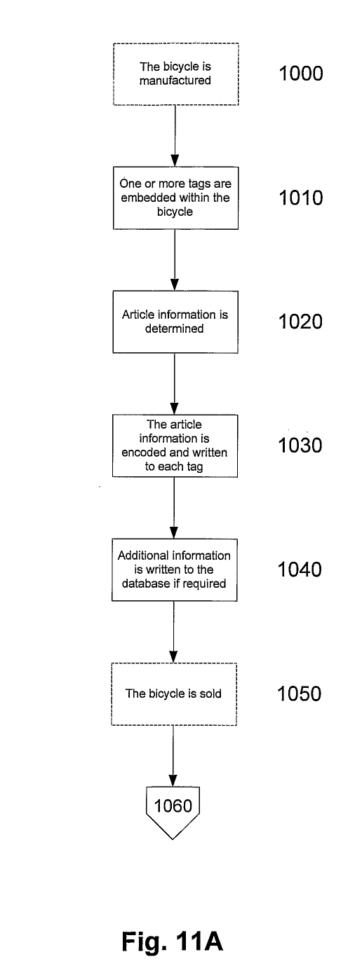

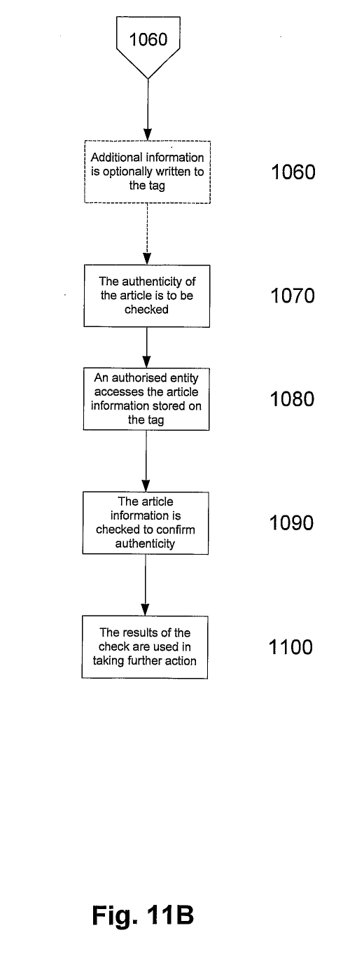

An example of the process for article authentication will now be described with reference to FIGS. 11A and 11B. In this example, the article being authenticated is a bike.

At step 1000 an entity manufactures the bicycle and embeds one or more tags within the bicycle at step 1010. This may be achieved in a number of manners and will depend on the preferred implementation. For example, the tags could be positioned within different parts of the bicycle during the manufacturing process, or may be added to the bicycle after construction has been completed. Accordingly, as the process may be applied to previously constructed bicycles, the step of manufacturing is optional in the sense that this may have been performed at some stage in the past.

Additionally, the tags may be provided at different locations within the bicycle. Thus, for example, a tag may be inserted into the seat tube, as well as into the handle bars and the frame of the bicycle.

The use of multiple tags may be desirable for a number of reasons, such as to provide enhanced security as will be discussed below, to ensure that different components of the bicycle are part of the original bike and not replacement parts, as well as to ensure all components are genuine components.

At step 1020 the manufacturer or another authorised entity, such as an insurer, determines article information that is then encoded and written to each tag at step 1030. The article information may include for example at least one of:
a unique article id;
manufacture information such as:
   manufacturer's identity;
   article make/model;
   year/date of manufacture;
   any other related information.
purchase information such as:
   date of purchase;
   owner information;
sales information such as:
   date of sale;
   seller/dealer information;
   an authority for sale from the previous owner;
insurance details;
owner details such as:
   name; and,
   address.

It will be appreciated however that additional information may be provided.

The article information is typically encoded on the tag utilising the procedures described above with respect to FIG. 7. Thus it will be appreciated that the article information is typically encrypted utilising strong encryption. Additional, access levels may be associated with the article information, with the article information typically being locked to prevent subsequent alteration.

Additional information may also be generated and written to a remote database if required at step 1040. The use of additional information can be used in providing additional levels of authentication of the article, or simply to store additional information regarding the manufacturer, the bicycle, or the like. Accordingly, the additional information may be article information, or “predetermined information” which will be described in more detail below.

At step 1050 the bicycle is optionally sold, at which point additional information can optionally be written to the tag at step 1060. This can be performed for example to allow an audit trail to be utilised as described with respect to FIGS. 10A to 10B. However, if the bicycle is already owned, these steps may not be required.

Once this is completed, the tag can then be used in authenticating the bicycle, and this may be used by an insurance company for provided reduced insurance premiums, as will be described below.

In any event, if the authenticity is to be checked at step 1070, an authorised entity accesses the article information stored on the tag at step 1080. This is typically achieved utilising a reading process similar to that described above with respect to FIG. 8. It will therefore be appreciated that this will typically require that the article information is decrypted utilising a strong encryption key or the like.

At step 1090 the article information is checked to confirm the authenticity of the bicycle. This is typically achieved by comparing the article information to predetermined information, as will be described in more detail below. The results of the check may be used in taking further action at step 1100.

Thus, for example, once a bicycle, or other article has been fitted with tags which allow the authenticity to be checked, this can allow an insuring entity to offer an insurance premium discount, as will be described below. This is possible because, if the article is recovered after being stolen, the process can be used to return the article to the rightful owner.

When performing repairs to a bicycle under warranty a manufacturer or repair specialist may wish to confirm the authenticity of the bicycle and its component parts. In order to achieve this, the entity performing the repairs can check the one or more tags embedded within the bicycle and confirm that the bicycle is a genuine bicycle covered by warrantee. This will allow the repairs to be performed.

Similarly, if an accident occurs or a fault occurs with the bike it may be necessary to claim insurance. In this instance, an insurance pay-out may only occur in the event that certain requirements are satisfied such as if the bicycle utilises authenticate parts and again a similar authentication process can be performed.

### Authenticity

In order to ensure that the authentication checks performed do correctly authenticate the article, it is typical to compare at least some of the article information read from the tag to some other predetermined information. This predetermined information can be any form of information that allows the article information to be confirmed as genuine and/or relating to the corresponding article.

The predetermined information can be obtained in a number of different manners, depending on the preferred implementation.

Thus, for example, the predetermined information can be reproduced visually on the article, provided in a remote database, or stored on a second tag coupled to the article. A further option is for the predetermined information to form part of the article information itself. In this case, the predetermined information could be formed from a signature or hash of part of the article information, as will be described in more detail below.

The comparison can be performed manually by the operator, by having the tag reader display at least part of the article information, and optionally the predetermined information, if this is derived from a tag or remote database. In this case, the operator views the displayed information and visually compares this either to the displayed predetermined information, or predetermined information provided on the article. In the event that the displayed information conforms to the predetermined information, this can indicate the article is genuine.

Alternatively, the comparison could be performed within the tag reader, with the tag reader providing an indication of the result of the comparison. Thus, for example, if the predetermined information is provided on the article, this can be entered by the user. Otherwise, the predetermined information can be downloaded from either a remote database, a second tag provided on the article, or even derived from the article information itself.

A further option is for the tag reader to be adapted to transfer the article information read from the tag to a remote processing system, which in turn determines the predetermined information, performs the authentication check, and returns an indication of the result of the authentication to the tag reader. This allows the tag reader to display the result of the authentication to the operator, without allowing either the operator, or the tag reader access to the predetermined information, which can in turn assist in maintaining the security of the predetermined information.

As far as the actual comparison is concerned, the manner in which this is achieved will depend on the nature of the article information and the predetermined information. For example, the predetermined information could simply be a duplication of all or part of the article information, in which case a simple comparison can be performed.

Alternatively, the predetermined and article information may be related by a predetermined function, such as a signature function or the like. For example, the article information may be a digital signature of the predetermined information. In this instance, once the article and predetermined information have been determined, the signature function, can be applied to the predetermined information, to thereby reconstruct the signature, which is then compared to the article information retrieved from the tag. Alternatively, the function can be applied to the signature to reconstruct the predetermined information, which is then compared to the retrieved predetermined information. The results of the comparison can then be used to authenticate the article. It will be appreciated that alternatively, the predetermined information may be a digital signature of the article information.

### Added Security

Attempts may be made to recreate, or fraudulently imitate article information provided on a tag, to thereby pass a fraudulent article off as authentic. For example, the article and predetermined information may include details of the manufacturer. However, this can allow third parties to determine details of a genuine manufacturer, encode this information on a tag, together with a fake article ID, and then provide the encoded tag on a duplicate bicycle to thereby attempt to pass the duplicate bicycle off as an authentic bicycle.

To reduce the chance of this occurring the article information may be in the form of a digital signature that can only be created utilising a secret key. By ensuring that a unique secret key is used, presence of the signature is indicative of the article information being created by an individual that had access to the secret key, and hence this is indicative that the article has been genuinely produced by the identified manufacturer.

In such a case, the signature could be produced utilising asymmetric public-private key encryption, with a public key being made available to allow third parties to verify the signature. Thus, for example, applying the public key to the signature allows the signature to be decrypted, with the resulting decrypted information being used to identify the manufacturer and hence the source of the bicycle.

It will be appreciated that a similar level of security is also provided by having the article information encrypted symmetrically using a secret key. In particular, if a strong symmetric encryption system is used, the ability to decrypt any information confirms that the information was encrypted utilising a secret key. Thus again, a similar level of authentication applies.

One issue with information encrypted using strong encryption is that the encrypted information itself can be copied from one tag to another, to thereby allow a duplicate tag to be created. In this instance, an entity examining a duplicate tag would be able to decrypt the encoded information thereon and determine the article or manufacture information. As a result, at first instance this may appear to be a genuine tag.

To reduce this problem, the article information can be cross-checked to a reference which varies for each article, such that the encrypted information is unique for each article. For example, it is typical for articles such as bicycles to include a unique serial number, or for an insured bicycle have a unique insurance number. In this particular instance by including data indicative of the unique serial number in the article information, then this allows the authenticity of the article information to be determined to a greater degree. It will be appreciated that this can be in the form of the unique article ID discussed above.

Thus, if the tag from one article is removed and coupled to an article having a different serial number, when the article information is compared to the serial number, which forms the predetermined information, there will be a disagreement, indicating the article is not authentic.

However, as the serial number could be copied if the fraudulent article is created from scratch, cross checking can be performed against remotely stored information such as the additional article information stored in the remote database. This again provides a degree of certainty as to the source of the information.

A further option, in the event that multiple tags are used on the bicycle, is to compare article information encrypted in each of the tags to allow correspondence of the article information to be confirmed. In this instance, rather than using identical article information on each tag, different article information can be used which is interrelated, for example via a predetermined algorithm. In this instance, when a entity is confirming the authenticity of the bicycle, the entity will decrypt the article information provided on each tag. The predetermined algorithm can then be applied to one set of article information and then compare the result of this to the article information stored on the other tag. Thus, the predetermined algorithm could for example be a hash function or the like.

The purpose behind this is to ensure that if an entity attempts to copy a tag to thereby pass off a duplicate bicycle as an authentic bicycle, it is necessary for the third party to copy all of the tags of a genuine bicycle and not simply one tag.

In order to prevent tags being copied, it is also possible to utilise a tag that will only present the contents of its memory when an authorised reader 10 is used.

As described above, this can be achieved by having the processor 11 provide authentication information to the tag processor 4. The level of authentication provided can be relatively straight forward, in the form of the presentation of a single identifier, or may be more complex, for example requiring the use of signatures, authentication certificates, or the like.

In general, more complex authentication procedures require additional processing to be performed by the tag processor 4, and this therefore increases the processing requirements of the tag processor 4 and hence increases the price of the tag.

It will therefore be appreciated that the nature of the authentication performed will be selected dependant on the particular use. If the article being authenticated is expensive, then it would typically be necessary to use a higher level of authentication as there can be a greater desire to copy tags.

It will be appreciated that whilst the mechanisms described above help reduce the likelihood of tag duplication, additional security can be performed by encoding an audit trail within the tag or a remote database. In particular, if an audit trail is encoded, using techniques similar to those described above with respect to FIGS. 10A and 10B, the current ownership status of the bicycle or other article can be determined via the tag. This allows an independent check to be performed when the authenticity check is performed.

For example, if an individual presenting the bicycle for repair is not the owner indicated in the tag, then this indicates that the tag is possibly a duplicate tag, or that the individual is not the genuine owner of the bike. In the event that this occurs, additional investigations can be performed to determine the authenticity of the bicycle. Thus, for example, remotely stored audit trails can be compared to an audit trail stored on the tag to determine the history or the article. In this case, if the comparison identifies any discrepancy, for example, indicating that the article is effectively in two places at once, then this indicates that the article is likely to be fraudulent.

### Insurance

As described above, the process may be used in insuring articles, and particularly high theft risk articles such as bicycles.

In particular, as this can be used to authenticate the identity of articles, this can greatly assist in allowing recovery of stolen articles. For example, if the police recover an article that may be stolen, they can read the article information stored on the tag and use this to determine the identity of the article, which in turn allows them to determine owner information, and thereby return the article. It will be appreciated that the owner information may be stored as part of the article information, either on the tag, or as part of a remote database, as described above. Alternatively, the identity of the article may be mapped to the owner identity in a separate database, in which case, the article information is used to authenticate the identity of the article, before this is used to cross reference a separate owner database.

In any event, being able to authenticate the article allows a higher rate of recovery of stolen goods. Accordingly, for articles fitted with a tag that allows the article's authenticity to be determined can be subject to reduced insurance premiums, as the recovery rate of the article tends to be higher.

Thus, in this instance, it is typical for an insuring entity to calculate a standard premium for the article, and then determine a reduced premium if an authenticity determining system, based on the above described process, is provided.

In one example, the insuring entity is involved in administering the authentication mechanism. Thus, for example, the insuring entity may arrange for the tag to be fitted to the article, and/or arrange for the article information to be generated or stored thereon.

In addition to this, the insuring entity may also generate and/or control the predetermined information used in authenticating the article. Thus, for example, the insuring entity may maintain a database containing the predetermined information. When it is required to authenticate the article, this can then be achieved by accessing the predetermined information from the database and performing the authentication as described above, or by having the article information submitted to the insuring entity to allow the authentication to be performed. In either case, this allows the insuring entity to restrict access to the predetermined information, thereby ensuring that the predetermined information cannot be modified or replicated, thereby improving the security of the authentication process.

Thus, in one example, when the article is to be authenticated, the tag reader determines the article information from the tag and submits this to the insuring entity using a suitable communications system. The insuring entity then authenticates the article and then returns an indication of the results of the authentication to the tag reader, allowing this to be displayed to an operator.

It will be appreciated that in this instance, the insuring entity may store additional information in the database, including the article owner's details (which may be for example in the form of the article information). In this instance, if the article is recovered, the authenticity of the article can be checked, the identity of the owner confirmed and the article returned to the owner.

By applying such authentication mechanisms to high theft risk articles, such as bicycles, this improves the rate of recovery for stolen or lost articles, thereby allowing reduced premiums (as compared to premiums for articles not including the authentication mechanism) to be offered.

By combining the authenticity determination with the audit trail, this allows further checks to be performed, including reviewing the history of any actions performed relating to the article. Thus, for example, this can be used to store the service history of a vehicle. By allowing the vehicle to be authenticated each time servicing is performed, and then associating this with the audit trail, this allows mechanics to confirm that they are working on the correct vehicle, whilst allowing vehicle owners/purchasers, to confirm that the vehicle has been correctly serviced. In the event that a fault occurs, the service history can then be reviewed to determine if incorrect servicing has been a factor in the fault.

It will be appreciated that this may be used in assessing whether a warranty has been invalidated, and accordingly, use of an authentication protocol can be made a warranty requirement. This again may be used in reducing insurance premiums, for example as this reduces the chance of a vehicle fault causing an accident.

### Further Features

Some additional features/functionality of the system will now be described in more detail below.

### Tag Reading

It will be appreciated by a person skilled in the art that if a tag is positioned inside the frame of a bicycle, the presence of the frame can reduce the effectiveness of read operations from the tag. In particular, it can be difficult for a reader 10 to successfully communicate with the tag 1 through the metal frame. In order to counteract the effects of this, the reader can be modified to use a telescopic antenna which may be inserted into the frame of the bicycle. Alternatively the tag can include an expanded antenna which increases the effectiveness of communication between the reader 10 and the tag 1 thereby reducing the interference effects caused by the frame.

### Tag Encoding

It will also be appreciated by persons skilled in the art that as the tag may be encoded in an office environment, it is not generally necessary to encode the tag utilising a handheld reader and desktop readers can be used.

In this instance, this allows specially configured readers to be used to provide modified data writing techniques. In particular, as the tag is provided in a label which is replaced on an annual basis, it is feasible to utilise a WORM (write once read many) tag by disabling the ability of the processor 11 or the modulator 15 to write information to the tag data store. It will be appreciated from this, that in one example, the modulator provided within the tag may not be provided with the ability to write data to the tag, with a modified reader 10 being used to provide the functionality of the modulator for writing purposes.

Furthermore, the use of a reading device with additional power can be utilised to successfully encode information even through a metallic portion of the label as discussed above.

### UV Marking

In order to assist with the identification of tags encoded and readable using the above described techniques, it is useful to provide UV fluorescent trace indicators on items which have an associated tag.

The purpose behind this is it can be difficult to locate tags by simply positioning the reader 10 in close proximity to an item. In particular, reading of tags 1 can be effected by intervening materials positioned between the antennas 2, 16, such as metals or the like, which may effect the inductive properties of the tuned circuit. Thus, failure to read information may be cause either by the absence of a tag or by an invalid read.

Accordingly, items which are provided with a tag are typically marked with UV fluorescent ink, or the like. The readers 10 can then include an optional black light source which causes the UV markings to fluoresce thereby allowing objects having a tag to be identified.

### Further Uses

The tag stores a large amount of information that can be subsequently used in a variety of manners. Thus in addition to providing registration information as discussed above, the information may be used to identify the article at any stage during the article's life.

This can be used to identify the article, for example in the event that the article is stolen, or required for a recall, or the like. It can also be used to provide article tracking for example, for use in issuing infringement notifications relating to speeding, parking tickets, or the like, as well as to allow for collection of road tolls.

Thus, in one example, the information written to the tag 1 will include details to identify the owner. In the event that asset is stolen, involved in an accident, is caught illegally parked, or the like, the tag can be used to determine the owner as required.

Accordingly, it will be appreciated by a person skilled in the art that as it will be desired to ensure that the owner information remains confidential and is only available to relevant authorities, the issuance of secret keys capable of decrypting the information stored on the asset registration tags is strictly controlled and limited to certain pre-authorised operators.

Entities which may be provided with authority to write and read information can include but is not limited to statutory authorities, Police, Law Enforcement Agencies, Finance Companies, Insurance Companies, Logistic Operators, Stock Controllers etc., depending on the circumstances in which the system is used.

### Secondary Database

As described above, the system includes the ability to write information to and read information from a secondary remote database, such as the database 36. It will be appreciated that this may be achieved in a number of manners.

For example, interaction with the database may be achieved solely through the use of the computer system, or alternative by providing appropriate communications within the reader 10. Depending on the implementation, this may use a database connected to a communications network, such as the Internet, or a private LAN or the like.

In this case, the reader advantageously uses a unique identifier encoded within the information stored on the tag 1 to uniquely identify the database record corresponding to the respective tag. This identifier might simply be a numeric reference to a particular database entry, or alternatively may be indicative of additional information, such as the respective database used. Thus, for example, the identifier could include a network address at which the database is provided, or alternatively may direct the reader 10 to a suitable LUT (look-up table) which provides details of the database.

### Antenna

In general the antenna 16 will be provided within the housing 21. This is feasible because the housing is formed from plastic which has a negligible effect on the properties of the tuned circuit, and can be easily accounted for the circuit configuration.

However, in some circumstances the RFID tags may be provided in a location which is difficult to read utilising such an antenna. For example when the RFID tags are incorporated into bikes it is typical to place the RFID tag within the bike frame. As the reader 10 is unable to communicate with the tag through the metal bike frame, it is therefore difficult to read the tag information correctly. Accordingly, the antenna may be in the form of a telescopic antenna which can be inserted into the frame of the bike. This ensures optimal inductive coupling between the antenna 16 and the antenna 2 thereby ensuring reading occurs correctly.

### Communications

Communication with the computer system may be achieved using a number of different techniques, including wired connections, such as an RS232 connection, a USB connection, or the like. Thus, in one example, 10 pin RJ 45 connector is provided on the bottom of the handle 22 to allow full duplex communication between the reader 10 and the computer system 30. However, alternatively, or additionally, wireless connections, such as Bluetooth or Zigbee can be used.

Furthermore, the reader 10 may be provided with GPRS functions and capabilities to allow wireless connectivity to the Internet or other communications networks.

### Display

The reader 10 includes a display such as a 112×64 pixel monochrome or colour graphics display which can be scrolled by pressing an associated input button. In this case, the display will provide general status information, as well as feedback during entry of information, authentication, and during the read process.

For example, if the trigger 13A is actuated then a message “READING TAG” will appear on the display until the tag is read, whereupon the information stored on the tag 1 will appear. An input button can be used to scroll through or otherwise review the information. In the event that no tag 1 can be detected, a “NO TAG FOUND” message can be displayed until the trigger is actuated again and the read cycle is repeated.

### Printer

A built in printer function or transmission capability of information to a printer from a serial port is typically implemented by the processor 11, allowing information from tags, or other information, to be printed. Alternatively, or additionally, a printer may be incorporated into the housing 20.

### Additional Visual & Aural Feedback

A speaker and/or additional visual indicators, such as an LED 14A may be used to provide additional feedback to an operator. For example, an audible sound can be generated when the reader 10 is connected to a computer system 30, or during a read process. A dual colour LED 14A can turn green when reading the tag, with the LED turning red when writing to the tag.

### Multiple Tags

The system can be adapted to write to multiple tags, such that the information and key selection process need only be performed a single time, with the processor repeating steps 370 and 380 each time the trigger 13A is depressed, but before step 390 is performed. In this case, software can prompt for the number of tags to be programmed which will then allow successive actuations of the trigger until all tags are programmed after which the next trigger will cause the gun to revert to read only mode, and purge the memory 12.

### Power Supply

When connected to the computer system, for example via a USB connection, power for the reader can be drawn from the computer. Otherwise a battery will be provided such as 9 volt alkaline battery. Alternately an AC power supply can be used.

To save power, the reader will typically turn on automatically if the trigger or the scroll button is actuated and automatically turn off if not used for 3 minutes.

### Encryption

In one example, all data written to the tag is 128 bit AES encrypted and then locked so it is impossible to erase. The encryption is based on a 64 bit secret key. Each reader 10 will typically be capable of storing a number of secret keys enabling the reader to be used for a corresponding number of different applications.

In one example, the encryption system uses a Unique ID of the tag 1, determined during the initial detection of the tag 1, and combines this with the secret key of the Reader/Writer to create a “hash” key based on the encryption algorithm. This means that only a device with the correct secret key and encryption algorithm will be able read and decipher the tag.

As previously mentioned dissemination of the secret keys is restricted to control access to the information, thereby helping to ensure appropriate security of the information stored on the tags. In order to control dissemination of the tags an authority may be to supply secret keys, with it being necessary for the owners of the readers to undergo some form of authorisation and authentication with the registration authority in order to be obtain the keys. The authority will then operate to record the secret key into the memory 12 of the tag reader 10, via a secure connection.

Alternatively the secret key may be generated locally, within the computer system 30, or the reader 10, again providing further control over dissemination.

However, use of a relevant authority allows common secret keys to be more easily provided to a number of readers. This allows different readers within an organisation, such as the Police force, to be programmed with the key centrally, thereby removing the burden from the Police force. Additionally, as some tags may want to be accessed via a number of different parties, in which case the authority may authorise the provision of the secret key to each party independently.

It will be appreciated from this that each secret key will typically associated with a respective type of information, or use scenario, examples of which will be described in more detail below. A further feature is that different encryption keys may be associated with different access levels. This provides additional security to information such that different users of the system are only able to decrypt different parts of the information.

### Remote Shutdown

In order to further prevent unauthorised use of the system it is possible for the readers 10 to incorporate a remote shutdown system. In particular, the remote shutdown system may be used in the event that a reader 10 is stolen. In this particular instance the reader 10 will typically include GPRS functionality or similar to allow wireless communication to be performed with a remote computer system. In this case, when a reader 10 is reported stolen the remote computer system can transfer predetermined commands to the reader 10 causing the processor 11 to shutdown the reader 10 and purge the contents of the memory 12, thereby deleting any secret keys contained, and preventing further use of the device.

Additionally, the reader 10 may include a GPS system to allow the location of the reader 10 to be monitored, which in turn allows lost or stolen readers 10 to be recovered.

### User Authentication

The nature of the operator ID can vary depending on the model of the reader 10, and the level of security desired.

The ID could include, for example, a PIN (Personal Identification Number), a password, a biometric signature of the operator, or the like. The manner in which the ID is generated and provided to the reader 10 will depend on the authentication mechanism used but may include for example scanning a thumb print to generate a biometric signature, entering a PIN number using the input 13, or the like.

### Monolithic IC

It is possible for the processor 11 and the memory 12 provided in the reader 10 to be formed on a monolithic IC. The use of the monolithic IC avoids the need to transfer secret keys via the bus 19 which can represent a point of weakness in the security of the system.

In particular, if a reader 10 is stolen, then it is possible to monitor signals transferred via the bus 19 and use these to determine the secret keys stored within the device. The secret keys can then be used to decrypt the information provided on tags. However by utilising a monolithic IC all transfer of the secret key is internal within a single chip and is therefore virtually impossible to derive by outside measurement of signals.

### Read/Write Details

It is possible to encode information regarding the write and read processes, either within the tag 1, or the remote database 36.

For example, it is possible to utilise time stamping to record either when information is written to a tag 1 or read from the tag 1. In the former case the time stamp is typically included within the encoded data so that it may not be subsequently modified. The time stamp can then be used for a number of purposes, such as to indicate expiry dates of the information. In this later case as there is only limited space on a tag and a significant number of read events may occur, each time a tag is read the reader 10 is adapted to provide an indication of the unique tag ID to the remote database 36 which then stores this together with a time stamp indicating when the device tag was read.

The information may also include personal information regarding the operator of the reader 10 such that the user of the reader 10 can be subsequently identified.

Persons skilled in the art will appreciate that numerous variations and modifications will become apparent. All such variations and modifications which become apparent to persons skilled in the art, should be considered to fall within the spirit and scope that the invention broadly appearing before described.

1. A method of determining the authenticity of an article, the method utilizing a tag having a tag data store, and wherein the method includes:
a) in a tag reader, determining article information from the tag data store;
b) comparing the article information to predetermined information, the predetermined information being obtained from at least one of.
i) the tag store;
ii) a database;
iii) a second tag provided on the article; and,
iv) the article; and,
c) authenticating the article dependent on the result of the comparison.

2. A method according to claim 1, wherein the method includes, in the tag reader, and in response to determining the article information, at least one of:
a) displaying the article information to allow visual comparison with the predetermined information; and,
b) comparing the article information to the predetermined information.

3. A method according to claim 1, wherein the predetermined information includes a digital signature and wherein the method includes, in the tag reader, at least one of:
a) decrypting the digital signature and comparing the decrypted digital signature to the article information; and,
b) encrypting the article information and comparing the encrypted article information to the digital signature.

4. A method according to claim 1, wherein the article information is at least partially encrypted to thereby prevent unauthorized access or alteration of the article information.

5. A method according to claim 4, wherein the article information includes:
a) a payload, the payload including the article information encrypted using a secret key; and,
b) a header, the header being indicative of the secret key, and wherein method includes, in the tag reader:
i) determining, from the header, an indication of the secret key;
ii) obtaining the secret key from a data store using the secret key indication; and,
iii) decrypting the payload using the secret key.

6. A method according to claim 1, wherein the method includes, in a tag reader:
a) determining an operator identifier indicative of an identity of an operator;
b) authenticating the operator using the operator identifier; and,
c) authenticating the article in response to a successful operator authentication.

7. A method according to claim 6, wherein the method includes, in the tag reader:
a) receiving the operator identifier from the operator;
b) comparing the operator identifier to a number of predetermined operator identifiers stored in a data store; and,
c) authenticating the operator in response to a successful comparison, wherein the operator identifier includes at least one of:
i) a biometric signature;
ii) a password; and,
iii) a PIN.

8. A method according to claim 6, wherein the method includes, in the tag reader:
a) determining from the article information at least one article information access level;
b) determining using the operator identifier and from operator details stored in a data store, one or more operator access levels;
c) comparing the article information access levels to the operator access levels; and,
d) authenticating the article in response to a successful comparison.

9. A method according to claim 1, wherein the tag is an REID tag, and wherein the method includes, in the tag reader, determining the identifier by:
a) generating a read signal, the tag being responsive to the read signal to modulate the read signal in accordance with the article information;
b) detecting modulation of the read signal; and,
c) determining the article information using the detected modulation.

10. A method according to claim 1, wherein the article information includes at least one of:
a) a unique article id;
b) manufacture information;
c) purchase information;
d) sales information;
e) insurance details; and,
f) owner details.

11. A method according to claim 1, wherein the at least one tag is embedded within the article.

12. A method according to claim 11, wherein the at least one tag is embedded within the article during manufacture.

13. A method according to claim 1, wherein the article information is locked so that it cannot be altered.

14. A method according to claim 1, wherein the article is a vehicle.

15. A method according to claim 14, wherein the article is a bicycle, and wherein the method is used for obtaining an insurance premium reduction relating to the bicycle.

16. Apparatus for determining the authenticity of an article, the article including a tag having a tag data store, and wherein the apparatus includes a tag reader for:
a) determining article information from the tag data store; and,
b) allowing a comparison of the article information to predetermined information, to thereby authenticate the article dependent on the result of the comparison, the predetermined information being obtained from at least one of.
i) the tag store;
ii) a database;
iii) a second tag provided on the article; and,
iv) the article.

17. Apparatus according to claim 16, wherein the tag reader includes at least one of:
a) a display for displaying the article information to allow visual comparison with the predetermined information; and,
b) a processor for comparing the article information to the predetermined information.

18. Apparatus according to claim 16, wherein the tag reader includes a communications system for communicating with a remote database to thereby determine the predetermined information.

19. A method for use in determining the authenticity of an article, the article including a tag having a tag data store, and wherein the method includes:
a) in a tag reader, storing article information in the tag data store; and,
b) providing predetermined information, the predetermined in formation being used to authenticate the article by comparing the predetermined information to the article information, the predetermined information being provided to at least one of:
i) in the tag store;
ii) in a second tag provided on the article; and,
iii) on the article.

20. (canceled)

21. Apparatus for use in determining the authenticity of an article, the article including a tag having a tag data store, and wherein the apparatus includes a tag reader for storing article information in the tag data store, the article information being related to predetermined information to allow authentication of the article by comparing the predetermined information to the article information, the predetermined information being provided at least one of.
a) in the tag store;
b) in a second tag provided on the article; and,
c) on the article.

22. A method associated with insuring an article, the method including:
a) providing an article authentication mechanism by:
i) storing article information in a tag having a tag data store, the tag being attached to the article;
ii) providing predetermined information for use in authenticating the article, the predetermined information being provided at least one of.
(1) in the tag store,
(2) in a database;
(3) in a second tag provided on the article; and,
(4) in the article; and,
b) insuring the article, the insurance premium being at a reduced level compared to the premium payable if the article did not include the authentication mechanism.

23. (canceled)

24. A method associated with an insured article, the method including:
a) in a tag reader, determining article information from a tag having a tag data store, the tag being attached to the article;
b) comparing the article information to predetermined information, the predetermined information being obtained from at least one of:
i) the tag store;
ii) a second tag provided on the article; and,
iii) the article; and,
c) authenticating the article dependent on the result of the comparison.

25. A method according to claim 24, wherein the method includes:
a) in the tag reader, transferring the article information to an insuring entity; and,
b) having the insuring entity authenticate the article.

26. (canceled)
